(19) United States
(12) Patent Application Publication
(10) Pub. No.: US 2004/0007192 A1
(43) Pub. Date: Jan. 15, 2004

(54) Four stroke internal combustion engine with isolated crankcase

(76) Inventor: Frank Keoppel, Ogden, UT (US)

Correspondence Address: R REAMS GOODLOE, JR. & R. REAMS GOODLOE, P.S., 24722 104TH. AVENUE S.E., SUITE 102, KENT, WA, 98030-5322, US

(21) Appl. No.: 10/396,297

(22) Filed: Mar. 25, 2003

Related U.S. Application Data
(63) Continuation-in-part of application No. 09/557,455, filed on Apr. 24, 2000, now Pat. No. 6,536,384.

(51) Int. Cl. F02B 75/02

(52) U.S. Cl. 123/65 R

(57) ABSTRACT

A four-stroke engine with an isolation chamber. The isolation chamber has a pressure-sensitive wall attached to or slidably mounted within the isolation chamber. The pressure-sensitive wall is substantially impervious to air, oil, and fuel. When the piston moves away from the crankcase, a vacuum is created in the crankcase. This draws the pressure-sensitive wall toward the crankcase, fluidwise, and movement of the pressure sensitive wall pulls air into the intake side of the isolation chamber through a one-way valve or time induction mechanism. When the piston moves toward the crankcase, increased pressure within the crankcase forces the pressure-sensitive wall away, fluidwise, from the crankcase and pushes air from the isolation chamber into the combustion chamber. The pressure-sensitive wall prevents oil from flowing from the crankcase. Power in a four-stroke engine is increased up to as much as 40%, without the necessity to employ superchargers or turbochargers.

### RELATED PATENT APPLICATIONS

This patent application claims priority from prior U.S. patent application Ser. No. 09/557,455 filed on Apr. 24, 2000, entitled Two-Stroke Internal Combustion Engine with Isolated Crankcase, the disclosure of which is incorporated herein in its entirety by this reference.

### TECHNICAL FIELD

This invention relates to a four stroke internal combustion engine, and more particularly to such an engine in which the crankcase is isolated from the combustion chamber.

### BACKGROUND

In a conventional two-stroke internal combustion engine, the vacuum caused by a piston moving away from the crankcase draws a mixture of fuel, air, and oil into the crankcase through a one-way valve or timed induction mechanism such as a piston or rotary valve. Increased pressure produced by the piston moving toward the crankcase forces the mixture of fuel, air, and oil into the piston cylinder on the side of the piston away from the crankcase and, therefore, into the combustion chamber, which is at the portion of the piston cylinder that is most distant from the crankcase, because such carbureted fuel cannot escape through the one-way valve or a now closed induction mechanism.

In most two cycle engines, the crankcase is used as a compressor. This technical approach requires relatively close) tolerances between the crank and the crankcase. It is also required that the crankcase be sealed. These factors isolate the crankcase from any lubrication system that may be located in other parts of the engine. Therefore, a secondary lubrication system is necessary. However, any oil in the crankcase would readily be pushed into the combustion chamber. Therefore, to replace the oil that is pushed into the combustion chamber, oil is continuously added to the crankcase, but only in small quantities. In conventional two-stroke engines this is accomplished by either oil injection or by utilizing fuel which as been pre-mixed with a suitable quantity of oil. But no matter how the lubrication is achieved, in prior art two-stroke engines, oil will be introduced into the combustion chamber and combusted. During the combustion process, such oil creates considerable smoke and other pollution.

Additionally, when a traditional two-stroke internal combustion engine of the crankcase compression type compresses the mixture of fuel, air, and oil (before the transport ports open), some of the fuel and oil can go past the piston skirt and into the exhaust port unburned. This adds to hydrocarbon pollution of the atmosphere and limits the attainable crankcase pressure.

However, some types of two-stroke internal combustion engines avoid introducing oil into the carbureted air by not using the crankcase as a pump. Instead, such engines utilize superchargers, which are heavy and expensive. Overall, superchargers are usually somewhat inefficient because the blower is always turning and putting a load on the engine even when there is no demand from the engine for fuel or air, i.e., when the transfer ports are closed.

Likewise, in four stroke engines, it has long been known that pressurizing the air on the intake side of the engine results in an increase in engine power output. Such power increases have long been accomplished with traditional superchargers (independently acting on the inlet air stream) and turbochargers (using exhaust gases to power the compression of the inlet air stream). And, even in four stroke engines, sealed crankcases have been utilized as inlet air compressors, such as is done with conventional two stroke engines.

In general, using the crankcase as a compressor requires the crankcase to be fully sealed. It also requires relatively close clearances between the crank and the crankcase itself. Unfortunately, such characteristics isolate the crankcase from oil that may be in other parts of the engine. Consequently, a secondary lubrication system is necessary. However, oil in the crankcase is normally readily pushed into the combustion chamber.

Some prior art two-stroke engines have incorporated devices to limit the amount of oil which flows into the combustion chamber, but most such devices are directed at capturing oil which has already been entrained, rather than preventing oil from being swept up in or injected into the entering combustion air supply stream.

Another problem with may prior art crankcase compression designs is the phenomenon of piston blow-by, wherein the fuel-air mixture is contaminated by high pressure burned gases passing downward through the piston rings and into the air or mixture being compressed. In other words, on the power stroke when the piston is cycling toward the crankcase, the charge of air or fuel-air mixture is diluted with hot products of combustion. Thus, it can be seen that it would be desirable to provide a crankcase compression technique which would avoid the possibility of encountering piston blow-by.

In summary, there remains a significant and as yet unmet need for a four-stroke engine which accomplishes high performance power output without appreciable emissions of pollutants due to combustion of lubrication oil as might normally be expected in two-stroke engines.

### SUMMARY

The present invention utilizes the pressure and vacuum cycles created within the crankcase of a crankcase compression four-stroke internal combustion engine to force air into the combustion chamber located within the piston cylinder of the engine. A flexible diaphragm, bellows, or floating piston is utilized to isolate the air that travels to the combustion chamber from the air within the crankcase. Therefore, no oil ever enters the combustion chamber from the crankcase.

As the piston moves away from the crankcase, a vacuum is created within the crankcase. This draws the flexible diaphragm, bellows, or floating piston which is located within an isolation chamber toward the crankcase, creating a vacuum on the side of the diaphragm, bellows, or floating piston away from the crankcase. This allows a mixture of fuel and air (or plain air if either (a) a fuel injection system that injects fuel into the combustion chamber is utilized or (b) a charge former is located between the isolation chamber and the transfer port) to be drawn through a one-way valve (or timed induction mechanism) and into the isolation chamber on the side of the diaphragm, bellows, or floating piston that is away from the crankcase.

When the piston moves toward the crankcase, the increased pressure pushes the diaphragm, bellows, or floating piston in the isolation chamber away from the crankcase. Because the mixture of fuel and air or pure air on the side of the diaphragm away from the crankcase cannot escape through the one-way valve or timed induction mechanism, such mixture of fuel and air or pure air is forced into the piston cylinder and, therefore, into the combustion chamber.

Such mixture of fuel and air or pure air is, therefore, pumped into the combustion chamber without ever being exposed to oil that lubricates the crankcase. Moreover, this effect is accomplished without the use of a supercharger or a turbocharger.

Preferably the piston is designed with a full-length skirt around the entire perimeter of the piston and with at least one ring around the piston. This ring is placed so that it is always between all ports and the crankcase in order to substantially preclude oil that is either maintained within and/or circulated through the crankcase from passing between the piston and the wall of the piston cylinder and thereby entering the exhaust port or the transfer port. (Oil in the exhaust port would be heated to such an extent that it would smoke or be pushed into the surrounding environment; oil in the transfer port would be pushed into the combustion chamber and create smoke during combustion which would then be exhausted to the surrounding environment.)

In a four-stroke engine, an isolation chamber is used with a sealed crankcase. In one embodiment, the isolation chamber may be provided substantially the same as my earlier design adapted for a two-stroke engine. A pressure-holding chamber or plenum chamber, and a one-way valve between the isolation chamber and the plenum chamber which allows the air to travel only from the isolation chamber toward the plenum chamber must be utilized, however. This is because during the downward action of the power stroke, the intake valves are closed so that air cannot enter the combustion chamber. Yet, due to action of the piston, such air would, without the additional one-way valve, be drawn back into the isolation chamber during the upward action of the exhaust stroke, thereby impeding the pumping action of the isolation chamber.

In a four-stroke engine, the isolation chamber taught herein precludes oil from reaching the combustion chamber (thereby allowing oil to be used in a conventional manner to lubricate the crankcase). Also, the isolation chamber taught herein eliminates the power robbing of piston blow-by contamination. In one embodiment, to avoid having pressure generated within the crankcase by piston blow-by impeding the pumping action of the isolation chamber, a timed valve is utilized to open (i.e., vent) the crankcase to the surrounding atmosphere at the time when the piston is at about its closest point of approach to the crankcase, i.e, the bottom dead center position of the piston.

In one embodiment, the plenum chamber can be provided with a pre-selected volume sufficient that, taking into account the engine displacement, the pressure variation within the plenum chamber will be minimized as the engine operates. Also, to prevent a vacuum from being created in a large area between the throttle and the intake valve, the throttle is preferably located near the intake valve. In one design, the carburetor or fuel injection nozzle is located in the vicinity of the throttle. In such designs, the intake chamber will pump only air into the plenum chamber. Thus, any airtight hollow member, including a hollow member that is a part of a structure on which the engine is mounted, can be utilized as part or all of the plenum chamber.

Thus, it can be appreciated that the addition of an isolation chamber with flexible diaphragm, as well as a piston having an oil isolation ring located to keep oil out of the transfer ports and exhaust ports, enables a four-stroke engine to function efficiently and provides an exhaust which is relatively smokeless, comparable to conventional four-stroke engines. This is an important improvement in the design and operation of four-cycle engines.

### BRIEF DESCRIPTION OF THE DRAWINGS

In order to enable the reader to attain a more complete appreciation of the invention, and of the novel features and the advantages thereof, attention is directed to the following detailed description when considered in connection with the accompanying drawings, wherein:

FIG. 1 illustrates a two-stroke engine with isolated crankcase utilizing a diaphragm as the pressure-sensitive wall.

FIG. 2 portrays a two-stroke engine with isolated crankcase employing a bellows as the pressure-sensitive wall.

FIG. 3 shows a two-stroke engine with isolated crankcase using a floating piston as the pressure-sensitive wall.

FIG. 4 depicts the embodiment of FIG. 1 wherein oil is circulated through the crankcase by a pump.

FIG. 5 illustrates a four-stroke engine with isolated crankcase during the compression stroke.

FIG. 6 illustrates a four-stroke engine with isolated crankcase during the power stroke.

FIG. 7 illustrates a four-stroke engine with isolated crankcase during the exhaust stroke.

FIG. 8 illustrates a four-stroke engine with isolated crankcase during the intake stroke.

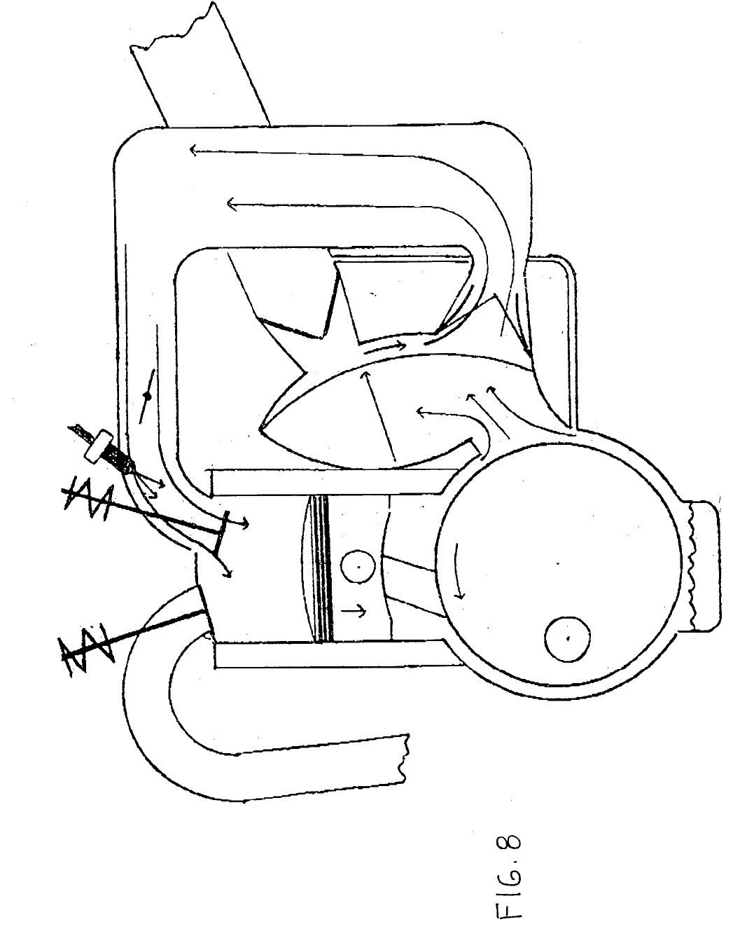

FIG. 9 illustrates a four-stroke engine with isolated crankcase having a large plenum chamber during the compression stroke.

The foregoing figures, being merely exemplary, contain various elements that may be present or omitted from actual implementations depending upon the circumstances. An attempt has been made to draw the figures in a way that illustrates at least those elements that are significant for an understanding of the various embodiments and aspects of the invention. However, various other elements of the two-stroke engine are also shown and briefly described to enable the reader to understand how various features may be utilized in order to provide an efficient, reliable engine.

### DETAILED DESCRIPTION

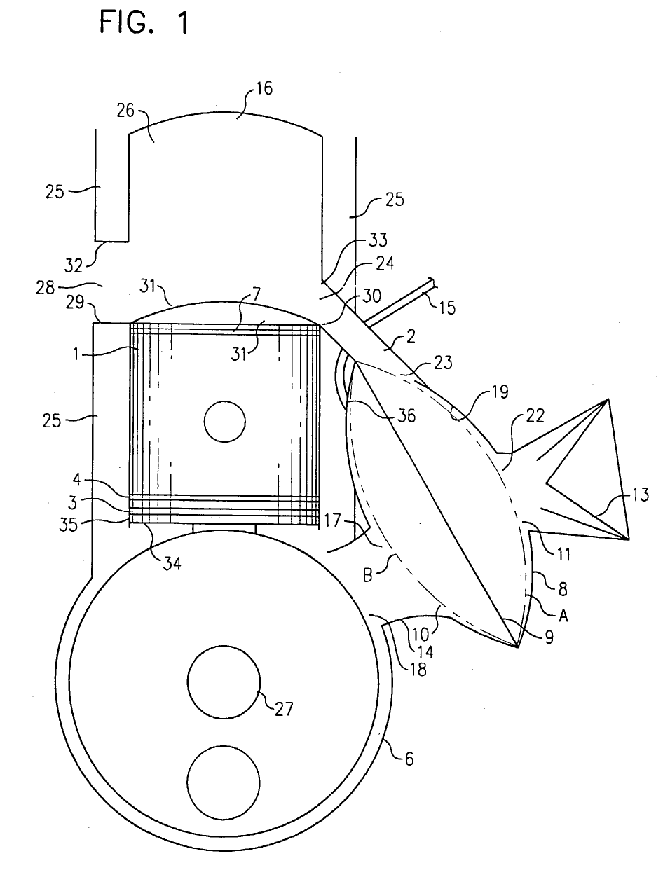

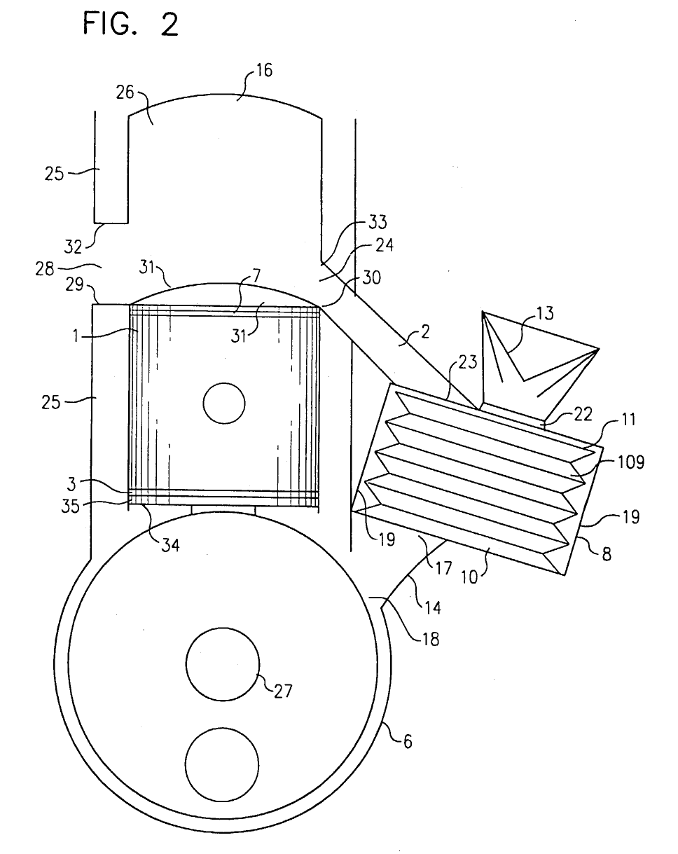

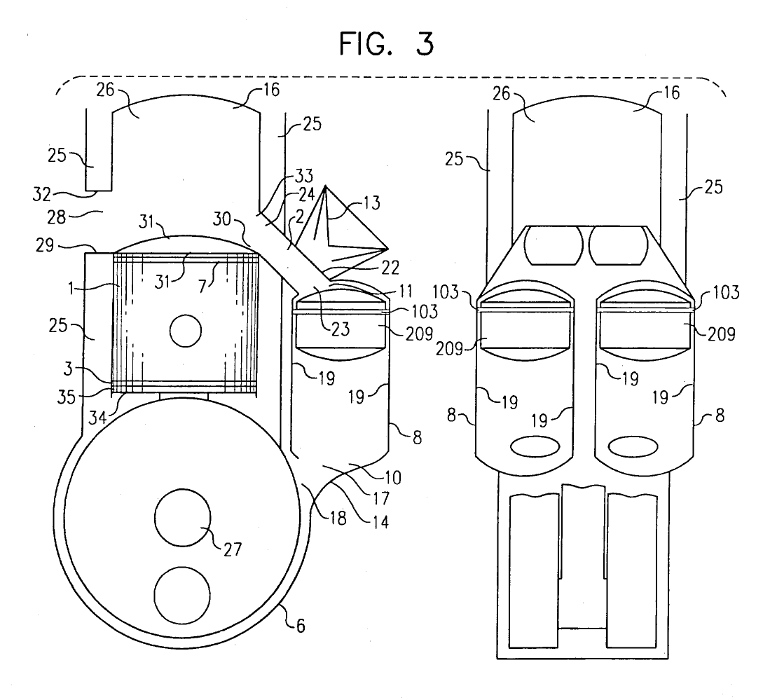

As taught in my earlier two-stroke engine patent application, illustrated in FIG. 1 is one embodiment of an engine with isolated crankcase. This configuration includes components of a traditional two-stroke internal combustion engine, while adding an isolation chamber 8 having a pressure-sensitive wall. Such a pressure-sensitive wall may be a flexible diaphragm 9 as illustrated in FIG. 1, a bellows 109 as portrayed in FIG. 2, or a floating piston 209 as shown in FIG. 3.

The isolation chamber 8 is attached to a sealed crankcase 6 and communicates with the crankcase 6 through an aperture termed the crankcase-side aperture 17 in the isolation chamber 8, and an isolation-side aperture 18 in the crankcase 6. Preferably, a hollow member termed the activation passage 14 is used to connect the isolation chamber 8 to the crankcase 6.

Whether utilized in a two-stroke or a four-stroke engine application, the pressure-sensitive wall is substantially impervious to air, oil, and the fuels used in an internal combustion engine. The pressure sensitive wall (9, 109, or 209, as applicable), together with the inner surface 19 of the isolation chamber 8, forms a displaceable barrier that is substantially impervious to air, oil, and the fuels used in an internal combustion engine. When a diaphragm 9 or a bellows 109 is utilized, the diaphragm 9 or bellows 109 is attached to the inner surface 19 of the isolation chamber 8 in such a manner that oil and air cannot pass from the side termed the crankcase side 10 of the isolation chamber 8 (normally the side that is toward the crankcase 6) to the side termed the intake side 11 of the isolation chamber 8 (normally the side that is away from the crankcase 6). Preferably, the diaphragm 9 is attached near the center of the isolation chamber whereas the bellows 109 is attached near the crankcase-side aperture 17. The floating piston 209 is slidably in contact with the inner surface 19 of the isolation chamber 8 so that neither oil nor air can pass between the floating piston 209 and the inner surface 19 of the isolation chamber 8. This can be accomplished with a floating piston seal 103 which can be a flared or flared and flexible rim 103 that is an integral part of the floating piston 209; a ring, termed a piston ring, 103; or any other form of seal that is well known in the art.

The ring 103 is preferably a pressure ring. The floating piston 209 is preferably nonmetallic, e.g. carbon fiber or nylon, which is beneficially lighter than a metallic piston 209. This is possible because the pressure, heat, and quantity of oil to which the floating piston 209 is exposed are considerably lower than the pressure, heat, and quantity of oil to which the piston 1 is subject.

Attachment of the diaphragm 9 or the bellows 109 to the isolation chamber 8 could, e.g., be done with an adhesive or, alternatively friction if the isolation chamber 8 is split in half and clamped together, preferably with a portion of the diaphragm 9 or the bellows 109 inserted between the halves of the isolation chamber 8.

A second aperture termed the intake aperture 22 in the isolation chamber 8 is on the intake side 11 of the isolation chamber 8. Connected to the isolation chamber 8 and communicating with the isolation chamber 8 through the intake aperture 22 is a flow regulator. The flow regulator can be either a one-way valve 13 that permits air to pass into, but not escape from, the intake side 21 of the isolation chamber 8 or a timed induction mechanism, such as a rotary valve, that is open when the piston 1 of the engine is moving away from the crankcase 6 but closed when the piston 1 of the engine is moving toward the crankcase 6 so that air will flow into, but not escape from, the intake side 21 of the isolation chamber 8.

A third aperture 23 is located in the intake side 11 of the isolation chamber 8. Also, an aperture designated as transfer port 24 exists in the wall 25 of a piston cylinder 26. The piston cylinder 26 is attached to the crankcase 6. The isolation chamber 8 is attached to the wall 25 of the piston cylinder 26 in such a manner that the isolation chamber 8 communicates with the piston cylinder 26 and, therefore, with the combustion chamber 16. The combustion chamber 16 is at the portion of the piston cylinder 26 that is the most distant from the crankcase 6, and communicates with the third aperture 23 and the transfer port 24. Preferably the isolation chamber 8 is connected to the wall 25 of the piston cylinder 26 with a hollow member named the transfer passage 2.

A piston 1 is slidably mounted within the piston cylinder 26. The piston 1 is connected, as is well known in the art, to the crankshaft 27.

Also in the wall 25 of the piston cylinder 26 is an additional aperture named an exhaust port 28. The top 32 of the exhaust port 28 is higher than the top 33 of the transfer port 24 so that, on the movement of the piston 1 toward the crankcase 6, the top 31 of the piston 1 will reach the top 32 of the exhaust port 28 before reaching the top 33 of the transfer port 24 to facilitate the movement of combustion gases from the combustion chamber 16 through the exhaust port 28.

Although for purposes of clarity of illustration only a single third aperture 23 of the isolation chamber 8, a single transfer port 24 in the wall 25 of the piston cylinder 26, and a single transfer passage 2 are shown. It is preferable to have multiple transfer ports 24 and multiple transfer passages 2 so as to enhance the efficiency in the scavenging of exhaust gases.

Carbureted air can be fed into the flow regulator, carburetion can occur between the isolation chamber 8 and the transfer port 24, or fuel can be injected into the combustion chamber 16.

The piston 1 has an oil ring 3 for precluding oil pushed by pressurized air from leaving the crankcase 6 and reaching the transfer port 24 and the exhaust port 28 by passing between piston 1 and the wall 25 of the piston cylinder 26. The bottom 34 of the piston 1 must have a full-length skirt 35 around the entire perimeter of the piston 1. A piston seal 3, which is preferably an oil ring 3 but which can be a flared or flared and flexible rim must be around the piston 1 sufficiently close to the bottom 34 of the piston that the piston seal 3 is always between the crankcase 6 and the bottoms 29, 30 of the exhaust port 28 and the transfer port 24.

At least one traditional pressure or compression ring 7 is also located around the piston 1 near the top 31 of the piston 1. Preferably; a pressure or compression ring 4 is placed around the piston 1 above and near the piston seal 3.

As can be understood from the preceding discussion, the pressure-sensitive wall, i.e., the diaphragm 9, the bellows 109, or the floating piston 209 isolates the oil within the crankcase 6 from the combustion chamber 16.

As the piston 1 moves away from the crankcase 6, the pressure is decreased within the crankcase 6, thereby, when a diaphragm 9 is utilized, drawing the diaphragm 9 toward the crankcase so that, when the piston 1 has reached its upper limit of travel, the diaphragm 9 is approximately in position B, as shown in the ghost illustration of FIG. 1. (Similarly, if a bellows 109 were used, the closed end of the bellows 109 would be drawn toward the crankcase 6; and if a floating piston 209 were employed, the piston would be pulled toward the crankcase 6.) This naturally draws air through the flow regulator, preferably the one-way valve 13, and the intake aperture 22 into the intake side 11 of the isolation chamber 8. Then, the movement of the piston 1 toward the crankcase 6, increases the pressure within the crankcase 6, thereby pushing the diaphragm 9 (or the closed end of the bellows 109 or the floating piston 209) away from the crankcase 6 so that, when the piston 1 has reached its lower limit of travel, the diaphragm 9 is approximately in position A, as depicted in the ghost illustration of FIG. 1.

Because the air on the intake side 11 of the diaphragm 9 (or the bellows 109 or the floating piston 209) cannot escape through the flow regulator, preferably the one-way valve 13,-such air is forced into the combustion chamber 16.

But since temperature changes within the crankcase 6 can interfere with the synchronization of movement between the piston 1 and the diaphragm 9 (or the bellows 109 or the floating piston 209), it is preferable to have a vent aperture 36 within the isolation chamber 8, the crankcase 6, or the activation passage 14 on the crankcase side 10 of the pressure-sensitive wall, which vent aperture 36 communicates between the surrounding environment and the isolation chamber 8, the crankcase 6, and the activation passage 14. This is accomplished by having the vent tube 15 attached to a vent aperture 36, which vent aperture can be in the crankcase side 10 of the isolation chamber 8, the crankcase 6, or the activation passage 14. Furthermore, to minimize the possibility of any contamination entering the vent aperture 36, it is preferable to have a hollow vent tube 15 attached to the isolation chamber 8, the crankcase 6, or the activation passage 14 around the vent aperture 36. The vent tube 15 communicates with, and leads away from, the vent aperture 36. Optionally, a filter can be placed on the end of the vent tube 15 that is away from the vent aperture 36.

Because of the sealed nature of the crankcase 6, if the temperature within the crankcase 6 increases rapidly as the piston 1 begins to travel upward, the diaphragm 9 (or the bellows 109 or the floating piston 209) will not begin moving toward the crankcase 6 immediately when the piston 1 begins to move away from the crankcase 6. Similarly, if the temperature within the crankcase 6 decreases rapidly as the piston 1 begins its movement toward the crankcase 6, the diaphragm 9 (or the bellows 109 or the floating piston 209) will not begin moving away from the crankcase 6 immediately when the piston 1 begins to move toward the crankcase 6.

A vent aperture 36 is selected to have a diameter of such a size that the vent aperture 36 will eliminate the delay in movement of the diaphragm 9 (or the bellows 109 or the floating piston 209) produced by temperature changes within the crankcase 6 while not permitting such a quantity of air to enter or leave the crankcase side 10 of isolation chamber 8, the crankcase 6, or the activation passage 14 that the action of the diaphragm 9 (or the bellows 109 or the floating piston 209) would be impeded to such an extent that performance of the engine would be negatively measurably affected.

Optionally, through any means that is well known in the art, the vent aperture 36 can be coordinated with the engine speed, e.g. the vent tube 36 can be closed when the throttle is closed and also when the engine is operating at very high speeds.

Air introduced into the combustion chamber 16 through the pumping action of the diaphragm 9 (or the bellows 109 or the floating piston 209) not only provides the air for combustion, but also scavenges the exhaust products of combustion through the exhaust port 28.

Although only a single piston cylinder 26 has been illustrated, an isolation chamber 8 can similarly successfully be employed with multiple cylinder two-stroke engines because the portions of the crankcase 6 associated with a given piston cylinder 26 would be sealed from and, therefore, would not communicate with one another. In such a case, each piston cylinder 26 would have its own isolation chamber 8.

Also, rather than using just one isolation chamber 8, it would be possible to use multiple isolation chambers 8 for a given piston cylinder 26.

As another option, if all pistons 1 of a multiple-cylinder two-stroke engine fire at substantially the same time, a single isolation chamber 8 can communicate with all the piston cylinders 26; and it would not be necessary to have the portions of the crankcase 6 associated with different piston cylinders 26 sealed from one another.

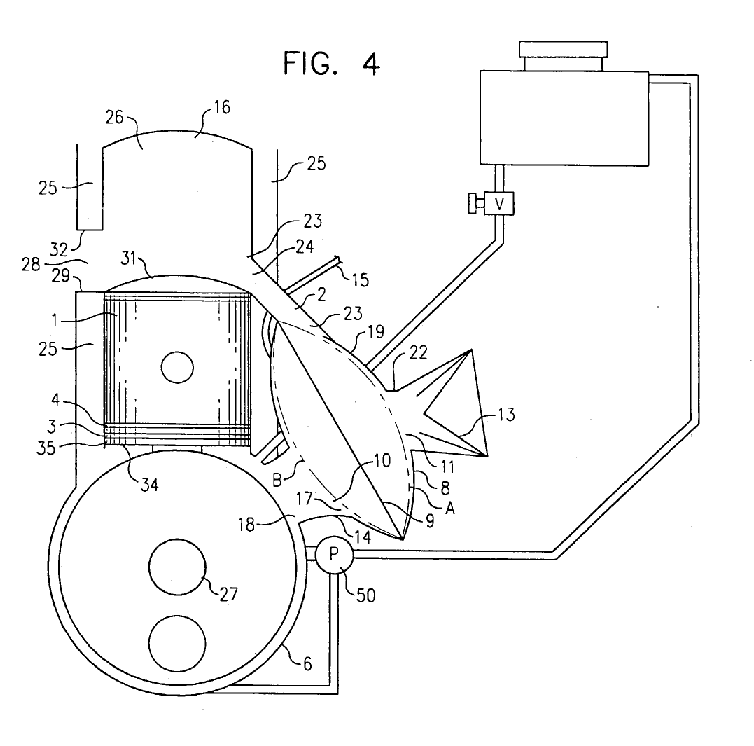

Oil can either be held within the crankcase 6 or, as illustrated in FIG. 4, circulated through the crankcase 6 by any means that is well known in the art for conventional four-stroke engines, such as by a pump 50.

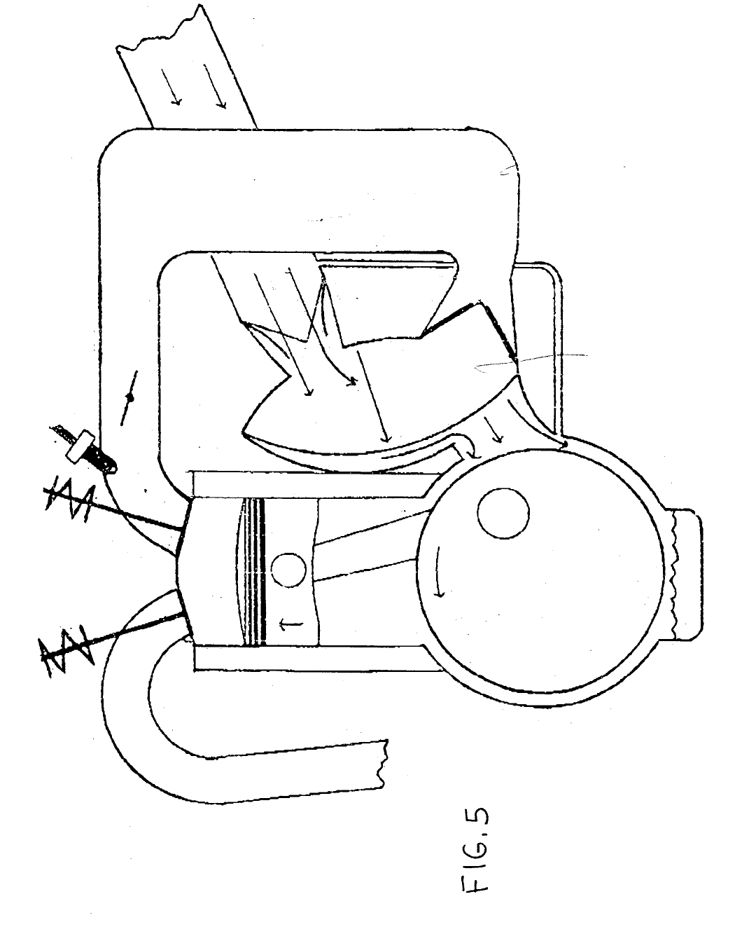

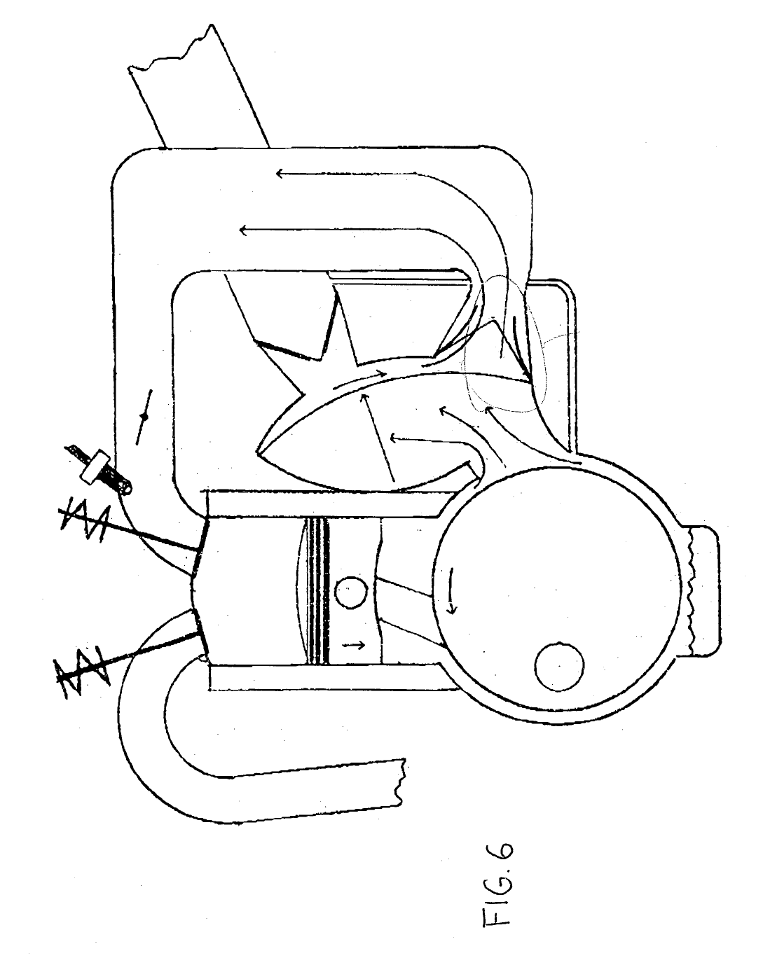

Attention is now directed more directly to the use of an isolation chamber in a four-stroke engine with isolated crankcase. On one embodiment, the isolation chamber 8 for the four-stroke engine is constructed like the isolation chamber 8 for the two-stroke engine. However, because as illustrated in FIG. 6, the intake valve or valves 101 are closed during the power stroke, when the descending piston 1 is forcing air from the isolation chamber 8 through the third aperture 23, a pressure holding chamber or plenum chamber 103 is needed to store the air that has been drawn into the isolation chamber 8 during the compression stoke, which is illustrated in FIG. 5, and forced from the isolation chamber 8 during the power stroke. To prevent such stored air from escaping back into the isolation chamber 8, an additional one-way valve 102 is necessary between the third aperture 23 and the plenum chamber 103.

A first open end 104 of the plenum chamber 103 communicates with the isolation chamber 8 through the additional one-way valve 102. A second open end 105 of the plenum chamber 103 communicates, through intake valve 101, with the intake port 106 of the piston cylinder 26.

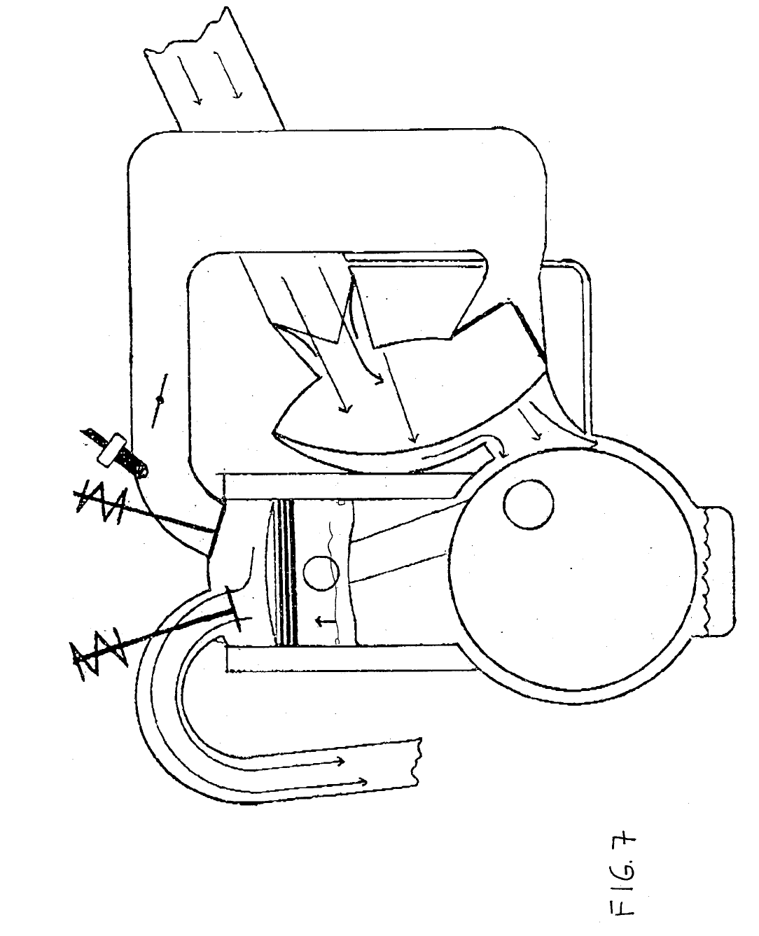

Since the downward movement of piston 1 toward the crankcase during the power stroke, as depicted in FIG. 6, and the downward movement of piston 1 toward the crankcase during the intake stroke, as depicted in FIG. 7, respectively, result in compression of the air in the crankcase, the air introduced into the combustion chamber 16 will be of greater density than atmospheric air that would otherwise be charged into the combustion chamber.

The additional one-way valve 102 precludes air from being drawn from the plenum chamber 103 into the isolation chamber 8.

In a four-stroke engine using crankcase compression as taught herein, the crankcase 6 must be sealed. However, other components in such a modified four-stroke engine using crankcase compression as taught therein with an isolation chamber, such as the exhaust port 107 and exhaust valve 108, are the same as in a conventional four-stroke engine. Also, because of the use of the isolation chamber 8, any traditional lubrication system 109 can be used to provide lubricating oil to the moving parts within the crankcase 6.

The vent aperture 36 communicates with vent tube 15, which tube 15 leads away from aperture 36. Aperture 36 is also attached to and communicates with an air supply tube 110 that may be connected to and in communication with the intake aperture 22 of the isolation chamber 8.

In order to avoid formation of a vacuum in the large area between the intake valve 101 and the throttle 111, the throttle 111 is preferably placed near the intake valve 101. The carburetor or fuel injection system utilized to form the mixture charged for combustion may also be located near the intake valve 101.

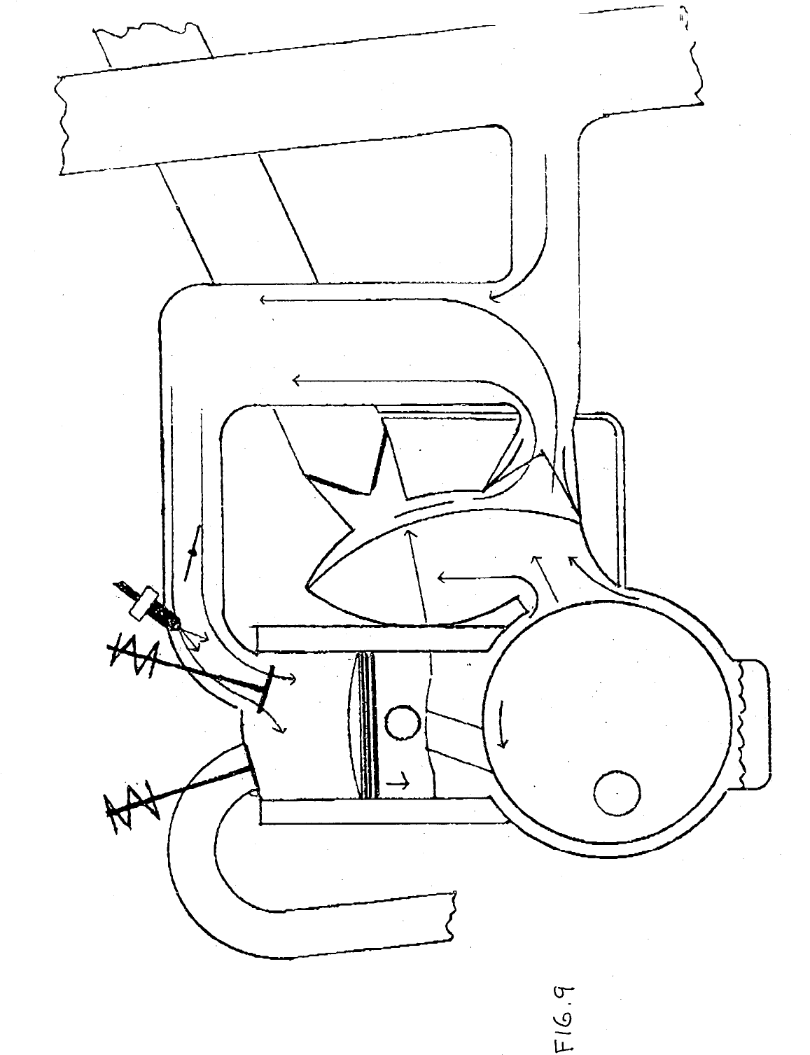

As discussed above, a large volume is desirable for plenum chamber 103. Optionally, as portrayed in FIG. 9, the plenum chamber 103 can be effectively increased in volume by utilizing any sealed, hollow member of the vehicle or other apparatus to which the engine is mounted, such as the frame of a motorcycle. Since neither oil nor fuel is necessarily within plenum chamber 103, in such a design, through flow is not necessary in such hollow structure used as part of the plenum chamber 103. Optionally, a relief valve 113 can be provided for plenum chamber 103, for the purpose of limiting the maximum pressure which can be established within the plenum chamber 103. Such a valve can also be used to minimize pressure variations seen on the discharge pressure to the piston.

Since piston blow-by is confined within the crankcase 6 by the isolation chamber 8, a timed valve 120 can be utilized to open the crankcase to the surrounding environment when the piston 1 is at or near the bottom dead center position. The opening of the timed valve 120 can be accomplished by suitable apparatus, such as a rotary valve, a poppet valve, or an electronically controlled magnetic valve.

Also, in a four-stroke engine design, it is not necessary to provide an oil ring near the bottom 34 of piston 1, as is the case in the two-stroke engine design.

The use of the isolation chamber as taught herein provides increased engine power output and efficiency without addition of mechanical parts such as superchargers or turbochargers. Positive intake pressure increase is provided without a supercharger or turbocharger. Power output can be increased up to 40% or 45% over standard four-cycle technology, when applied to applications such as motorcycles or personal watercraft. Also, the design provides an oil efficient, smokeless design, when compared to prior art devices. And, increased engine life may be expected, since full engine lubrication can be expected. The design is easy to manufacture, and is of light weight and compact design that can be integrally incorporated into a device using such a four-stroke engine, such as a motorcycle or personal watercraft. Moreover, the design is stackable, in the use of pairs of cylinders, i.e., twin cylinders for many small four-stroke applications, can be utilized. Alternately, 4, or 6, or even 8 cylinder engines may utilize the teachings hereof to achieve increased power output.

With the use of the isolation chamber taught herein in conjunction with a four-cycle engine, such an engine can be thought of as being a five-cycle engine which provides increased intake pressure without supercharging or turbocharging.

It is to be appreciated that various aspects and embodiments of the engine designs described herein are an important improvement in the state of the art of four-cycle engines. Although only a few exemplary embodiments have been described in detail, various details are sufficiently set forth in the drawings and in the specification provided herein to enable one of ordinary skill in the art to make and use the invention(s), which need not be further described by additional writing in this detailed description. Importantly, the aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. It is therefore to be understood that within the scope of the appended claims, the invention(s) may be practiced otherwise than as specifically described herein. Thus, the scope of the invention(s), as set forth in the appended claims, and as indicated by the drawing and by the foregoing description, is intended to include variations from the embodiments provided which are nevertheless described by the broad interpretation and range properly afforded to the plain meaning of the claims set forth below.

1. An internal combustion engine with isolated crankcase, comprising:
a four-cycle engine, said engine comprising
a sealed crankcase having an aperture and a crankshaft;
a piston cylinder attached to said crankcase, said piston cylinder having a combustion chamber and also having a wall with a transfer port which has a top and a bottom and an exhaust port that has a top and a bottom with the top of the exhaust port being higher than the top of the transfer port;
a piston slidably mounted within said piston cylinder, said piston connected to the crankshaft of said crankcase, and having
a top,
a bottom
a pressure ring located around said piston near the top of said piston;
an isolation chamber, said isolation chamber having
an inner surface,
a crankcase side,
an intake side,
a pressure-sensitive wall, said pressure-sensitive wall forming a barrier between said crankcase side and said intake side, and being substantially impervious to air, oil, and the fuels used in an internal combustion engine;
a crankcase-side aperture on the crankcase side of said isolation chamber,
an intake aperture on the intake side of said isolation chamber, and
a third aperture on the intake side of said isolation chamber, said isolation chamber communicating with said crankcase through the crankcase-side aperture and the aperture in said crankcase; and
said isolation chamber communicating with said piston cylinder through the third aperture and the transfer port;
a plenum chamber, said plenum chamber comprising a first end and a second end, said plenum chamber communicating with said isolation chamber through said first end, and with the intake port of the piston cylinder through said second end;
a flow regulator connected to said isolation chamber and communicating with said isolation chamber through the intake aperture so that air may pass into, but will not escape outward through said flow regulator from, the intake side of said isolation chamber.

2. The apparatus as set forth in claim 1, further comprising, on the crankcase side of said pressure-sensitive wall, a vent aperture, said vent aperture communicating between the surrounding environment and said engine element, said vent aperture having a diameter of such a size that said vent aperture eliminates delay in movement of said pressure-sensitive wall produced by temperature changes within said crankcase, while not permitting such a quantity of air to enter or leave said crankcase that the action of the pressure-sensitive wall would be impeded to such an extent that performance of the engine would be measurably negatively affected.

3. The apparatus as set forth in claim 1, further comprising a timed valve, said timed valve opening said crankcase to the surrounding environment when said piston is approximately at the bottom dead center position.

4. The apparatus as set forth in claim 3, further comprising a throttle, said throttle located near said intake valve of said piston cylinder, and a fuel metering device, said last mentioned device located adjacent said intake valve.

5. The apparatus as set forth in claim 4, further comprising a frame having a hollow member, and wherein said engine is affixed to said frame, and wherein hollow member comprises at least a portion of said plenum chamber.

6. The apparatus as set forth in claim 2, further comprising:
a hollow vent tube attached around, communicating with, and leading away from said vent aperture.

7. The apparatus as set forth in claim 3, wherein:
said isolation chamber is connected to said crankcase via an activation passage; and
said isolation chamber is connected to the wall of said piston cylinder with a transfer passage.

8. The apparatus as set forth in claim 3, further comprising an activation passage, and wherein the activation passage contains said vent aperture.

9. The apparatus as set forth in claim 1, wherein said isolation chamber is provided by opposing hollow concave elements arranged to define an interior space and having a flexible membrane therein sufficiently displaceable to effectively utilize most of the interior space of said isolation chamber when said flexible membrane moves from fully deflection on the to full deflection on discharge.

10. The apparatus as set forth in claim 1, wherein performance of said engine is increased over equivalent four-stroke engine without addition of said isolation chamber.

11. The apparatus as set forth in claim 10, wherein performance of said engine is increased up to 40% over equivalent four-stroke engine without addition of said isolation chamber.

12. The apparatus as set forth in claim 10, wherein performance of said engine is increased up to 45% over equivalent four-stroke engine without addition of said isolation chamber.

13. The apparatus as set forth in claim 1, wherein:
said pressure-sensitive wall comprises a diaphragm attached to the inner surface of said isolation chamber in such a manner that oil and air cannot pass from the crankcase side of said isolation chamber to the intake side of said isolation chamber.

14. The apparatus as set forth in claim 1, wherein:
said pressure-sensitive wall comprises a bellows attached to the inner surface of said isolation chamber in such a manner that oil and air cannot pass from the crankcase side of said isolation chamber to the intake side of said isolation chamber.

15. The apparatus as set forth in claim 1, wherein:
said pressure-sensitive wall comprises a floating piston, said floating piston being slidably in contact with the inner surface of said isolation chamber so that neither oil nor air can pass between said floating piston and the inner surface of said isolation chamber.

16. A process for manufacture of a four-stroke internal combustion engine with isolated crankcase, comprising:
attaching a sealed crankcase having an aperture and a crankshaft to a piston cylinder having at the most distant portion of the piston cylinder from said crankcase, a combustion chamber and also having a wall with a transfer port which has a top and a bottom and an exhaust port that has a top and a bottom with the top of the exhaust port being higher than the top of the transfer port;
slidably mounting, within said piston cylinder, a piston having
a top,
a bottom with a full-length skirt around the entire perimeter of the piston,
a piston seal around the piston sufficiently close to the bottom of the piston that the piston seal is always between said crankcase and the bottoms of the transfer port and the exhaust port, and
a pressure ring located around said piston near the top of the piston; connecting the piston to the crankshaft of the crankcase;
attaching to the crankcase an isolating chamber having an inner surface, a crankcase side, and an intake side,
a pressure-sensitive wall, the pressure-sensitive wall being substantially impervious to air, oil, and the fuels used in an internal combustion engine and the pressure-sensitive wall, together with the inner surface of the isolation chamber, forming a barrier that is substantially impervious to oil, air, and the fuels used in an internal combustion engine;
a crankcase-side aperture on the crankcase side of the isolation chamber,
an intake aperture on the intake side of the isolation chamber; and
a third aperture on the intake side of the isolation chamber,
so that the isolation chamber communicates with the crankcase through the crankcase-side aperture and the aperture in the crankcase;
connecting the isolation chamber to the wall of said piston cylinder and communicating with said piston cylinder through the third aperture and the transfer port; and
connecting the isolation chamber to a flow regulator so that the isolation chamber communicates with the flow regulator through the intake aperture in order to assure that air may pass into, but will not escape from, the intake side of the isolation chamber.
